(19) United States
(12) Patent Application Publication
(10) Pub. No.: US 2026/0211923 A1
(43) Pub. Date: Jul. 23, 2026

(54) SERVICING QUERIES USING A DYNAMIC LARGE LANGUAGE MODEL CASCADE

(71) Applicant: Dell Products L.P., Round Rock, TX (US)

(72) Inventors: Anamika Chatterjee, Kolkata (IN); Chris Lazar, Round Rock, TX (US); Saurabh Jha, Leander, TX (US)

(21) Appl. No.: 19/035,574

(22) Filed: Jan. 23, 2025

(51) Int. Cl. G06F 16/3349; G06F 40/205; G06F 40/284; G06F 40/40

(52) U.S. Cl. CPC G06F 16/3349; G06F 40/205; G06F 40/284; G06F 40/40

(57) ABSTRACT

A method for servicing queries includes receiving a query from a client. The method also includes parsing the query to generate a plurality of tokens, sending the plurality of tokens and the query to a scheduler, and grouping the query based on the plurality of tokens. Further, the method includes making a first determination that an answer to the query can be generated from a cache entry in a cache associated with a token in the plurality of tokens. The method also includes generating, based on the determination, the answer to the query. Finally, the method includes sending the answer to the client in response to their query.

### BACKGROUND

Users often issue queries related to unstructured archival data. Due to the unstructured nature of the archival data, servicing the queries can be time consuming and resource intensive.

### BRIEF DESCRIPTION OF DRAWINGS

Certain embodiments disclosed herein will be described with reference to the accompanying drawings. However, the accompanying drawings illustrate only certain aspects or implementations of one or more embodiments disclosed herein by way of example and are not meant to limit the scope of the claims.

FIG. 1.1 shows a diagram of a system in accordance with one or more embodiments disclosed herein.

FIG. 1.2 shows a diagram of a manager in accordance with one or more embodiments disclosed herein.

FIG. 1.3 shows a diagram of a cache in accordance with one or more embodiments disclosed herein.

FIG. 1.4 shows a diagram of a cache entry in accordance with one or more embodiments disclosed herein.

FIG. 2 shows a flowchart for a method for structuring data in accordance with one or more embodiments disclosed herein.

FIG. 3.1 shows a flowchart for a method for generating a query answer based on a cache entry in accordance with one or more embodiments disclosed herein.

FIG. 3.2 shows a flowchart for a method for generating a query answer based on a draft token in accordance with one or more embodiments disclosed herein.

FIG. 4 shows a computing system in accordance with one or more embodiments disclosed herein.

### DETAILED DESCRIPTION

Specific embodiments will now be described with reference to the accompanying figures. In the following detailed description of the embodiments disclosed herein, numerous specific details are set forth in order to provide a more thorough understanding of one or more embodiments disclosed herein. However, it will be apparent to one of ordinary skill in the art that the one or more embodiments disclosed herein may be practiced without these specific details. In other instances, well-known features have not been described in detail to avoid unnecessarily complicating the description.

In the following description of the figures, any component described with regard to a figure, in various embodiments disclosed herein, may be equivalent to one or more like named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase “operatively connected” may refer to any direct connection (e.g., wired directly between two devices or components) or indirect connection (e.g., wired and/or wireless connections between any number of devices or components connecting the operatively clients). Thus, any path through which information may travel may be considered an operative connection.

Entities often have significant archival data relating to the function and performance of proprietary and non-proprietary inventions used throughout the entities business life. Often, sorting through such archival data, which is typically stored in an unorganized and inconsistent manner, is time consuming and inefficient. This inefficiency often prohibits entities from answering questions (or ATTORNEY servicing queries) related to the archival data or using the data in any meaningful manner.

In certain scenarios, an entity, such as a corporation, client, or user, may wish to answer a question related to the archival data. The traditional approach requires individually parsing through the entirety of the archival data to find an answer to the question. Alternate traditional approaches include feeding the archival data into a large language model (LLM) in an attempt to quickly sort and identify archival data associated with the question. In this alternate traditional approach, proprietary archival data may often include restrictions that prohibit the use of a proprietary LLM. Further, due to the unstructured and inconsistent storage practices often associated with archival data, proprietary LLMs may struggle to sort and utilize the inputted archival data in a meaningful and efficient manner. This can potentially lead to inaccuracies and significant delays in receiving answers to questions.

For at least the reasons discussed above, a different approach is needed to address these challenges and improve the usability of archival data to generate answers in response to queries. Embodiments disclosed herein relate to a method for servicing queries on data, which may be archival data and/or unstructured archival data. As a result of the processes discussed below, one or more embodiments disclosed herein advantageously ensure that queries related to archival data can be processed efficiently, without significant delay, and accurately provide responses across a range of queries.

The following describes one or more embodiments.

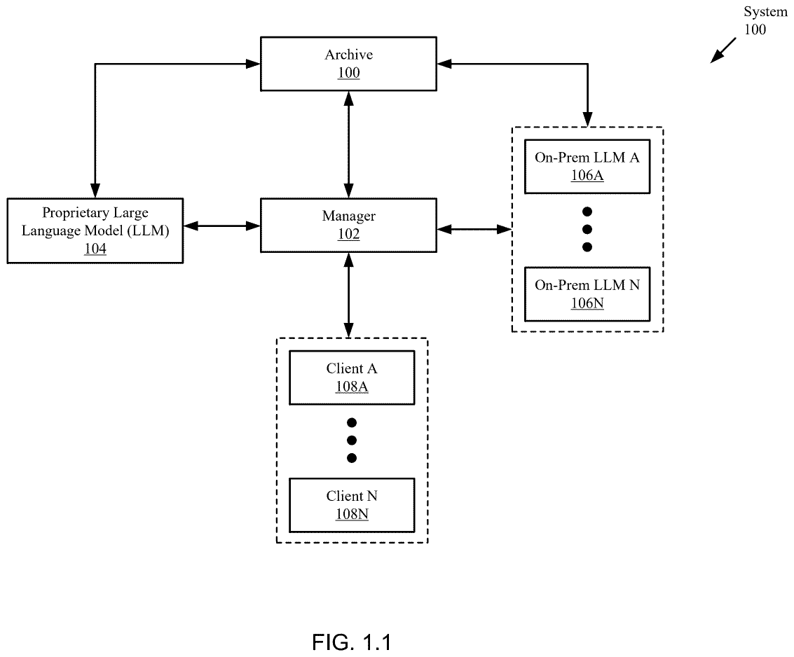

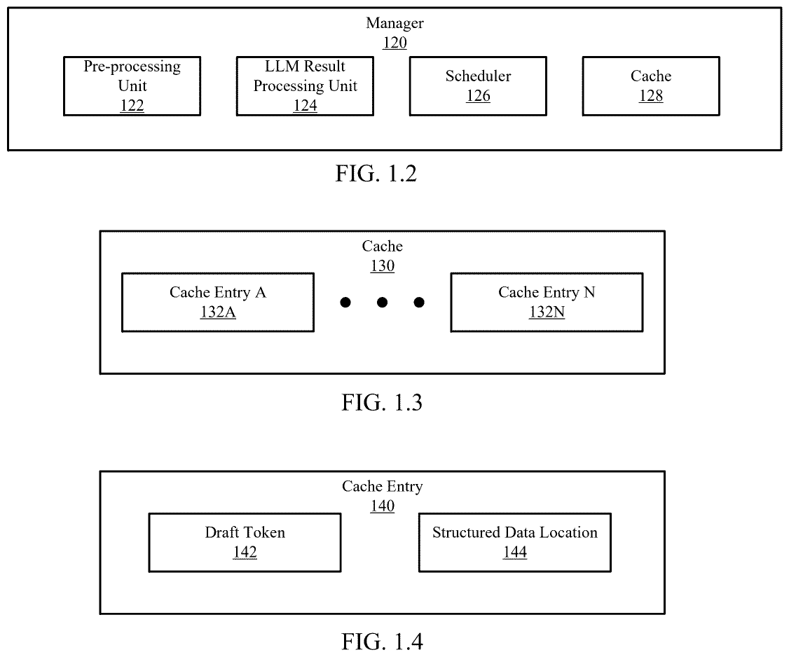

FIG. 1.1 shows a system in accordance with one or more embodiments. The system may include an archive (100), a manager (102), a proprietary large language model (LLM) (104), any number of on-prem LLMs (e.g., on-prem LLM A (106A), on-prem LLM N (106N), etc.), and any number of clients (e.g., client A (108A), client N (108N), etc.). The system may include additional, fewer, and/or different components without departing from the scope described herein. Each component may be operably/operatively connected to any of the other components via any combination of wired and/or wireless connections. Each of these system components is described below.

In one or more embodiments, the archive (100), the manager (102), the proprietary large language model (LLM) (104), any number of on-prem LLMs (e.g., on-prem LLM A (106A), on-prem LLM N (106N), etc.), and any number of clients (e.g., client A (108A), client N (108N), etc.) may be operatively connected one another through a network (not shown) (e.g., a local area network (LAN), a wide area network (WAN) such as the Internet, a mobile network, any other network type, or any other connection type not listed). Further, the network may encompass various interconnected, network-enabled subcomponents (or systems) (e.g., switches, routers, gateways, etc.) that may facilitate communications between the archive (100), the manager (102), the proprietary large language model (LLM) (104), any number of on-prem LLMs (e.g., on-prem LLM A (106A), on-prem LLM N (106N), etc.), and any number of clients (e.g., client A (108A), client N (108N), etc.). Moreover, the archive (100), the manager (102), the proprietary large language model (LLM) (104), any number of on-prem LLMs (e.g., on-prem LLM A (106A), on-prem LLM N (106N), etc.), and any number of clients (e.g., client A (108A), client N (108N), etc.) may communicate with one another using any combination of wired and/or wireless communication protocols.

In one or more embodiments, the archive (100) includes functionality to store archival data and structured data received from the pre-processing unit (discussed in FIG. 1.2). The archive (100) may be volatile storage, non-volatile storage, or any combination thereof. Examples of a storage include (but are not limited to): a hard disk drive (HDD), a solid-state drive (SSD), random access memory (RAM), Flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, and virtualized memory. Further, in one or more embodiments, the archival (100) may include functionality to receive and send data to a manager (102), and any LLMs (e.g., 104, 106A, 106N, etc.).

As used herein, archival data is data associated with business functions and inventions throughout the life of a business. As a non-limiting example, archival data includes technical datasheets for legacy equipment that is no longer in production. In one or more embodiments, such legacy equipment may still be used and require maintenance and upkeep, which further requires referencing the archival data (technical datasheets). Additionally, archival data can be in any data form including, but not limited to, a portable document format (PDF), a text file such as one created from a word processing program, images and slideshows, and/or any other medium that can be used to store, organize, and display data. Said another way, archival data can be stored in any manner, including an unstructured and unorganized manner.

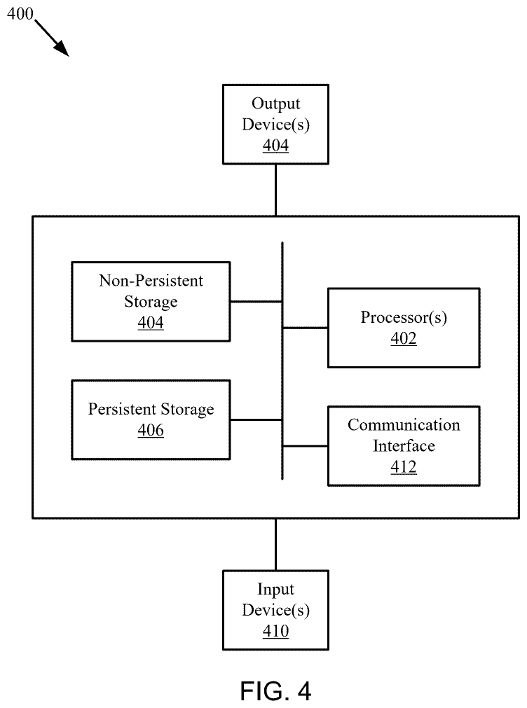

Turning now to the manager (102), the manager (102) may be a computing device (e.g., 400, FIG. 4) that manages (e.g., creates, monitors, facilitates, modifies, removes, etc.), at least one or more proprietary LLMs (104), one or more on-prem LLMs (e.g., 106A, 106N, etc.), an archive (100), one or more clients (e.g., 108A, 108N, etc.), and/or the connections among the clients (e.g., 108A, 108N, etc.) and the other components in the system.

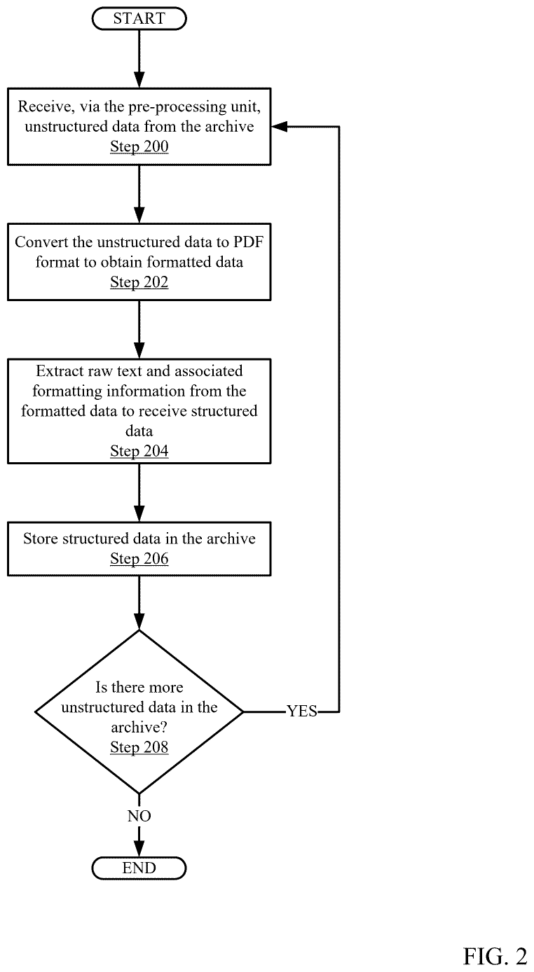

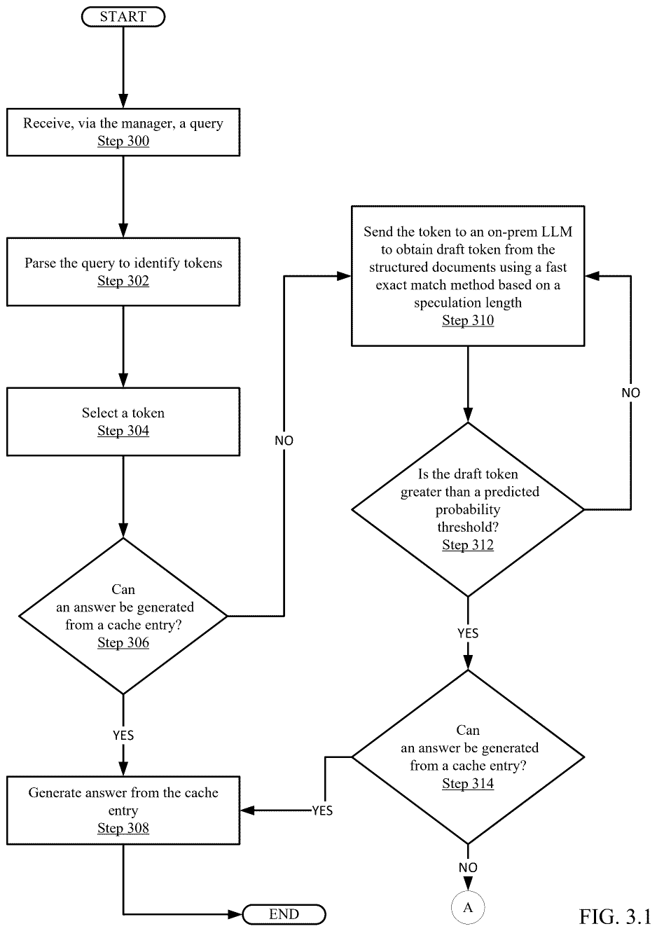

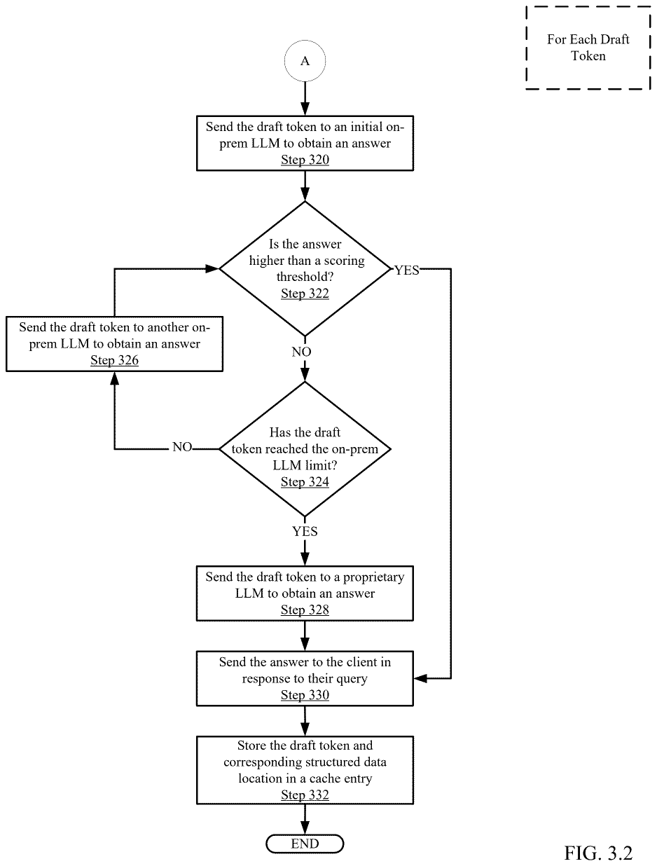

In one or more embodiments, the manager (102) may include the functionality to manage unstructured data, structured data, and LLM generated answers. Additional details about the manager (102) are described in FIG. 1.2. One of ordinary skill will appreciate that the manager (102) may perform other functionalities without departing from the scope of the embodiments disclosed herein. In one or more embodiments, the manager (102) may be configured to perform all, or a portion, of the functionalities described in FIGS. 2 and 3.1-3.2. The manager (102) may be implemented using hardware (e.g., any number of integrated circuits for processing computer readable instructions), software (e.g., a computer program), or any combination thereof.

Turning now to the proprietary LLM (104), the proprietary LLM (104) may be a type of artificial intelligence based on a deep learning algorithm that may be developed by a third-party entity. In one or more embodiments, the proprietary LLM (104) may be accessed for a fee and/or require monetary transactions to use. The proprietary LLM (104) may be implemented using a software-as-a-service (SaaS) model. The proprietary LLM (104) may be implemented using other mechanisms without departing from the scope of the disclosure.

In one or more embodiments, the proprietary LLM (104) may include the functionality to be trained on large data sets (e.g., archival data in the archive (100)), receive queries associated with the large data sets, and generate answers based on the queries. In one or more embodiments, the proprietary LLM (104) may further include the functionality to generate tokens based on the queries to more efficiently process the queries. As used herein, a token is a basic unit of text that an LLM processes. As a non-limiting example, the query, which may be a sentence, can be broken down into individual words or characters. Each word or character may be a token used by an LLM. In one or more embodiments, the proprietary LLM (104) may receive queries or other inputs (e.g., tokens associated with queries) from the manager (102) based on the scheduler (126, FIG. 1.2). The scheduler is further discussed in FIG. 1.2.

Turning now to the on-prem LLMs (e.g., 106A, 106N, etc.), the on-prem LLM (e.g., 106A, 106N, etc.) may be a type of artificial intelligence based on a deep learning algorithm that may be developed internally or by a third-party entity. In one or more embodiments, the on-prem LLMs (e.g., 106A, 106N, etc.) may be open-source or otherwise free to use. Said another way, the on-prem LLMs (e.g., 106A, 106N, etc.) may not require monetary transactions to generate outputs. In one or more embodiments, the on-prem LLMs (e.g., 106A, 106N, etc.) may include the functionality to limit generated answers based on a quota. As a non-limiting example, the on-prem LLMs (e.g., 106A, 106N, etc.) may only allow 100 generated answers (more generally, outputs) before ceasing or requiring monetary transactions to continue generating more outputs.

In one or more embodiments, the on-prem LLMs (e.g., 106A, 106N, etc.) may include the functionality to be trained on large data sets (e.g., archival data in the archive (100)), receive queries associated with the large data sets, and generate answers based on the queries. In one or more embodiments, the on-prem LLMs (e.g., 106A, 106N, etc.) may further include the functionality to generate tokens based on the queries to more efficiently process the queries. In one or more embodiments, the on-prem LLMs (e.g., 106A, 106N, etc.) may receive queries or other inputs (e.g., tokens associated with queries) from the manager (102) based on the scheduler (126, FIG. 1.2). Further, on-prem LLMs (e.g., 106A, 106N, etc.), in one or more embodiments, may pass generated tokens to additional on-prem LLMs (e.g., 106A, 106N, etc.) based on direction from the manager (102).

In one or more embodiments, the clients (e.g., 108A, 108N, etc.) may be physical or logical computing devices configured for hosting one or more workloads, or for providing a computing environment whereon workloads may be implemented. The clients may provide computing environments that are configured for, at least: (i) workload placement collaboration, (ii) computing resource (e.g., processing, storage/memory, virtualization, networking, etc.) exchange, and (iii) protecting workloads (including their applications and application data) of any size and scale. The clients (e.g., 108A, 108N, etc.) may correspond to computing devices that one or more users use to interact with one or more components of the system (100). One of ordinary skill will appreciate that the client (e.g., 108A, 108N, etc.) may perform other functionalities without departing from the scope of the embodiments disclosed herein.

Turning to FIG. 1.2, FIG. 1.2 shows diagram of a manager (120) in accordance with one or more embodiments disclosed herein. The manager (120) includes a pre-processing unit (122), an LLM result processing unit (124), a scheduler (126), and a cache (128). Each of these components is described below.

Turning to the pre-processing unit (122), the pre-processing unit (122) may be a computing device (e.g., 400, FIG. 4) that processes archival data to store in the archive (100). In one or more embodiments, the pre-processing unit (122) includes the functionality to receive archival data from archive (100) via the manager (102) and process the archival data to increase data compatibility with connected LLMs (e.g., 104, 106A, 106N, etc.). As part of processing, in one or more embodiments, the pre-processing unit (122) may include the functionality to convert archival data types (e.g. text files, images, etc.) to other types (e.g., PDF). Further, in one or more embodiments, the pre-processing unit may include functionality to maintain the archival data formatting and structure while converting. As a non-limiting example, the archival data may in the form of an email with headings and subheadings. The pre-processing unit (122) may convert the email to a PDF format and, within the PDF, retain the same headings and subheadings as in the original email. In one or more embodiments, the pre-processing unit (122) may be implemented as a logical device.

Turning now to the LLM result processing unit (124), the LLM result processing unit (124) may be a computing device (e.g., 400, FIG. 4) that processes LLM results generated by one or more LLMs (e.g., 104, 106A, 106N, etc.). In one or more embodiments, the LLM result processing unit (124) includes functionality to compare LLM outputs (e.g., answers to queries, tokens associated with queries, etc.) to a threshold to confirm accuracy. In one or more embodiments, the LLM result processing unit (124) may include the functionality to establish a threshold for comparing the LLM outputs. The LLM result processing unit (124) may be implemented using hardware (e.g., any number of integrated circuits for processing computer readable instructions), software (e.g., a computer program), or any combination thereof. In one or more embodiments, the LLM result processing unit (124) may be implemented as a logical device.

In one or more embodiments, the threshold may be based on the predicted probability of the LLM outputs and functions as a confidence threshold. Said another way, if the LLM output is below a certain confidence, the output is voided, and a new token is created to pursue a different output. This voiding mechanism, also called a token exiting mechanism, ensures that resources are not wasted on a low confidence token thereby ensuring the LLM generated answers are accurate. In one or more embodiments, the threshold may be a static threshold or a dynamic threshold that adjusts based on certain factors including token size, overall confidence values, and/or acceptance rates. Additional factors may be incorporated to determine the threshold without departing from the scope of the embodiments disclosed herein.

Turning now to the scheduler (126), the scheduler (126) may be a computing device (e.g., 400, FIG. 4) that batches queries and determines the query processing order by one or more components (e.g., 104, 106A, 106N, 124, etc.). In one or more embodiments, the scheduler (126) includes the functionality to identify query attributes and group queries based on those attributes. As used herein, query attributes are identifying qualities associated with queries such as query length, initial tokens, number of tokens, etc. Additional query attributes may be used by the scheduler (126) without departing from the scope of the disclosure herein. In one or more embodiments, the scheduler (126) may be implemented as a logical device.

In one or more embodiments, the scheduler (126) includes the functionality to increase the system (100) processing speed by batching and processing queries in parallel. As a non-limiting example, take two queries (query A is “Company X offers” and query B is “Company X provides”. The queries have similar query attributes: three token length (where each token represents a word) and identical starting tokens (“Company X”). Accordingly, the scheduler may batch both queries together and send them to an LLM (e.g., 104, 106A, 106N, etc.) to be processed at the same time. Continuing the example, the scheduler may have multiple batches of queries that, when sent to the LLM (e.g., 104, 106A, 106N, etc.), are processed in parallel, significantly increasing the query response time and the overall system (100) processing speed. In one or more embodiments, the scheduler (126) may include the functionality to batch tokens and/or queries without departing from the scope of the disclosure herein.

Turning now to the cache (128), the cache (128) may be implemented as one or more hardware component that stores data. The cache may be implemented using any combination of volatile or non-volatile storage without departing from the technology. In one or more embodiments, the cache (128) includes functionality to temporarily store data used by the system (100). In one or more embodiments, the data may be stored in an adaptive radix tree data structure. As used herein, the adaptive radix tree is a data structure that utilizes dynamic parent and child nodes to store data. By storing the data in the adaptive radix tree data structure, the system (100), via the manager (120) can quickly perform lookups to access the data.

Turning to FIG. 1.3, FIG. 1.3 shows a diagram of a cache (130) in accordance with one or more embodiments disclosed herein. The cache (130) includes one or more cache entries (e.g., cache entry A (132A), cache entry N (132N), etc.). Each component is described below.

In one or more embodiments, each cache entry (e.g., 132A, 132N, etc.) may be a pointer storing location information of data entries in the archive (100). In one or more embodiments, each data entry may correspond to files used to answer a stored query. As used herein, a stored query is a previously answered query where the tokens associated with the query are stored in the cache (130) as parent nodes and the files used by the tokens to generate the answer are stored as child nodes. Further, the files are stored as pointers pointing the file location within the archive (100). Said another way, each cache entry (e.g., 132A, 132N, etc.) may correspond to a previously generated answer. Further, in one or more embodiments, the manager (120) may utilize cache entries within the cache (130) to answer queries prior to sending queries to any LLM (e.g., 104, 106A, 106N, etc.). This is further discussed in FIG. 3.1 below.

Turning to FIG. 1.4, FIG. 1.4 shows a diagram of a cache entry (140) in accordance with one or more embodiments disclosed herein. The cache entry (140) includes a draft token (142) and a structured data location (144). Each of these components is described below.

In one or more embodiments, the draft token (142) is a token from the query as described above. In one or more embodiments, the token may be an initial token, or a subsequent draft token generated by an LLM (e.g., 104, 106A, 106N, etc.) after processing the initial token. Any token may be stored in the cache entry (140) without departing from the scope of the disclosure.

In one or more embodiments, the structured data location (144) is a pointer pointing to structured data (e.g., files) used to generate an answer based on the associated draft token (142). In one or more embodiments, each cache entry may contain both the draft token (142) and the structured data location (144). In this manner, the cache entry can correspond to a previously generated answer and, in one or more embodiments, may be used by the manager (120) to answer subsequent related queries.

Turning to FIG. 2, FIG. 2 shows a flowchart for a method for structuring data in accordance with one or more embodiments disclosed herein. The method may be performed by, for example, the pre-processing unit (122, FIG. 1.2). Other components in the system may perform this method without departing from the scope of the disclosure.

While the various steps in the flowchart shown in FIG. 2 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel. Further, one or more steps in FIG. 2 may be performed concurrently with one or more steps in FIG. 3.1-3.2.

In step 200, the pre-processing unit (122) receives unstructured data from the archive (100). The unstructured data may exist in any form such as a text file, an email, an image, etc. It may be stored in the archive (100) in any manner and for any time without departing from the scope of the disclosure. Further, the pre-processing unit may receive the unstructured data in any format without departing from the scope of the disclosure herein.

In step 202, the pre-processing unit coverts the unstructured data into a PDF format to obtain formatted data. This allows for a consistent expected result where the formatted data can be processed in the same manner irrespective of the original unstructured data format. Those skilled in the art will appreciate that formats other than PDF may be used without departing from the invention.

In step 204, the pre-processing unit extracts raw text and associated formatting information from the formatted data to receive structured data. As used herein, extracting involves an intelligent processing method where the pre-processing unit identifies positional identifiers (e.g., headings, page numbers, paragraph numbers, etc.) associated with data sections and chunks the data sections with the positional identifiers to create the structured data. As a non-limiting example, a vehicle technical data sheet may include a heading for an engine and, under the heading, associated information explaining technical aspects of the engine. Further, the same technical data sheet may also include a heading for a braking system and, under the heading, associated information explaining technical aspects of the braking system. The pre-processing unit will identify the two different headings and separate the data from the PDF based on those two headings to obtain two separate structured data. In one or more embodiments, the structured data may include additional organization features without departing from the scope of the disclosure herein. Continuing the previous example, the two structured data (i.e., two separate data items), one relating to the engine and the other, the braking system, may also exist under another heading identifying the technical datasheet itself or the subject relating to two structured data.

In step 206, the manager may receive the structured data from the pre-processing unit and store the structured data into the archive. The structured data may be stored in the same location as the unstructured data or in a different location. Any number of partitions or other organizational features may be used within the archive without departing from the scope of the disclosure herein.

In step 208, the manager makes a determination as to whether there is more unstructured data in the archive. In one or more embodiments, if the determination is YES, the method proceeds back to step 200. In one or more embodiments, if the determination is NO, the method ends.

Turning to FIG. 3.1, FIG. 3.1 shows a flowchart for a method for generating a query answer based on a cache entry in accordance with one or more embodiments disclosed herein. The method may be performed by, for example, the on-prem LLM (e.g., 106A, 106N, etc., FIG. 1.1). Other components in the system may perform this method without departing from the scope of the disclosure.

While the various steps in the flowchart shown in FIG. 3.1 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel. Further, one or more steps in FIG. 3.1 may be performed concurrently with one or more steps in FIGS. 2 and 3.2.

In step 300, the manager receives a query from a client (e.g., client A (108A), client N (108N), etc.). In one or more embodiments, the query may be associated with data within the archive. As a non-limiting example, the query may be related to the vehicle technical datasheet described in a prior example.

In step 302, the manager parses the query to identify initial tokens. The tokens may represent words or phrases within the query. As a non-limiting example, if a query is “Does a vehicle need engine A” the tokens may be “Does”, “a vehicle”, “need”, and “engine A”. In one or more embodiments, the manager may send the query to an on-prem LLM (106A, 106N, etc.) to generate the initial tokens without departing from the scope of the disclosure herein.

In step 304, the manager, via the scheduler (126), selects a token. The token may be a token within a batch of tokens grouped by the scheduler. Further, in one or more embodiments, the manager may select the entire batch of tokens. As a non-limiting example, if a batch of tokens are all grouped due to having identical starting tokens, such as “engine A”, then the manager, via the scheduler, may choose to select the entire group. Additional grouping and selection criteria may be used without departing from the scope of the disclosure herein.

In step 306, the manager makes a determination as to whether an answer can be generated from a cache entry based on the selected token. In one or more embodiments, the token may correlate to a stored draft token (142) within a cache entry (140) in the cache (130). In one or more embodiments, if the determination is YES, the manager determines that the selected token does correlate to a draft token in the cache and proceeds to step 308. In one or more embodiments, if the determination is NO, the method proceeds to step 310.

In step 308, based on the positive determination in step 306, the manager generates the answer by retrieving the stored answer from the cache entry associated with the token. In one or more embodiments, following a generated answer, the method may end.

Turning to step 310, in step 310, based on a negative determination in step 306, the manager sends the token to an on-prem LLM to obtain subsequent tokens using structured data referenced by the structured data location (144) in the cache entry associated with the initial token. In this manner, even if the answer is not immediately identified by the cache entry, the search complexity significantly decreases as the cache entry can point to the file where the answer may be. The subsequent tokens may be obtained using a fast exact match method based on a speculation length. As used herein, speculation length is the length of the initial token/tokens. As a non-limiting example, the token “Does” has a speculation length of one while the token “a vehicle” has a speculation length of two. Further, in one or more embodiments, multiple tokens may be used by the fast exact match method. Continuing the example, when multiple tokens are used, the speculation length is the aggregate of the individual tokens. Here, if the tokens used are “Does” and “a vehicle” the speculation length is now three.

As used herein, the fast exact match is a one-to-one mapping of tokens to the structured document. As an example, if the token represents “a vehicle”, the fast exact match will search the structured data for the exact phrase “a vehicle”. In one or more embodiments, the tokens used may represent phrases, single words, or even partial words without departing from the scope of the disclosure herein.

Turning to step 312, in step 312, the manager makes a determination as to whether the subsequent token is greater than a predicted probability threshold determined by the LLM result processing unit (124). In one or more embodiments, if the answer is NO, the manager aborts additional LLM generation related to that subsequent token and the method reverts to step 310 to generation further subsequent tokens. In one or more embodiments, if the answer is YES, the method proceeds to step 314.

In step 314, the manager makes a determination as to whether an answer to the query can be generated from a cache entry associated with the subsequent token generated in step 310. In one or more embodiments, if the determination is YES, the method proceeds to step 308, and an answer is generated from the cache entry. In one or more embodiments, if the determination is NO, the method proceeds to step 320 in FIG. 3.2.

Turning to FIG. 3.2, FIG. 3.2 FIG. 3.2 shows a flowchart for a method for generating a query answer based on a draft token in accordance with one or more embodiments disclosed herein. The method may be performed by, for example, the proprietary LLM (104, FIG. 1.1). Other components in the system may perform this method without departing from the scope of the disclosure.

While the various steps in the flowchart shown in FIG. 3.2 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel. Further, one or more steps in FIG. 3.2 may be performed concurrently with one or more steps in FIGS. 2 and 3.1. Further, the steps in FIG. 3.2 are completed for each draft token and, in one or more embodiments, may be completed for each draft token in parallel.

In step 320, based on the negative determination in step 314, the manager sends the subsequent token to an initial on-prem LLM to generate an answer. In step 322, the manager makes a determination, using the LLM result processing unit, as to whether the generated answer is higher than a scoring threshold. If the determination is YES, the method proceeds to step 328.

If the determination is NO, the method continues to step 324. In step 324, the manager makes a determination as to whether generating an answer using the initial on-prem LLM exhausted the subsequent token's on-prem LLM limit. In one or more embodiments, each token may only be used by an on-prem LLM a certain number of times before the manager may determine that the on-prem LLMs cannot answer the question. Accordingly, if the determination is YES, the subsequent token is sent to a proprietary LLM in step 328. Alternatively, if the determination is NO, the method proceeds to step 326.

In step 326, the manager sends the subsequent draft token to a second on-prem LLM to obtain the answer. In one or more embodiments, the method reverts to step 322 and, if an answer is not successfully generated (based on the threshold), the method continues to subsequent on-prem LLMs (e.g., the nth on-prem LLM) until a satisfactory answer is generated or until the subsequent token's on-prem LLM limit is met. As a non-limiting example, a subsequent token may have an on-prem limit of ten. Accordingly, the subsequent token can pass through ten on-prem LLMs before being sent to step 328 if an answer is not generated. At any point in those ten permutations, if a satisfactory answer is generated, the on-prem LLM loop is aborted, and the method proceeds to step 330.

Continuing to step 328, in step 328, following a positive determination in step 324, the manager sends the subsequent token to a proprietary LLM (104) to obtain an answer. In one or more embodiments, the proprietary LLM may be used as a last resort to reduce overall query costs.

In step 330, the manager sends the generated answer to the client in response to their query. In step 332, the manager stores the generated answer, tokens, and corresponding structured data location (as a pointer) in the cache via a cache entry. Any method to store the generated answer may be used without departing from the scope of the disclosure herein. In one or more embodiments, the method ends here.

Embodiments of the disclosure may be implemented using computing devices. FIG. 4 shows a diagram of a computing device (400) in accordance with one or more embodiments. The computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (408) (e.g., Bluetooth interface, infrared interface, network interface, optical interface, etc.), input devices (410), output devices (408), and numerous other elements (not shown) and functionalities. Each of these components is described below.

In one embodiment, the computer processor(s) (402) may be an integrated circuit for processing instructions. For example, the computer processor(s) (402) may be one or more cores or micro-cores of a processor. The computing device (400) may also include one or more input devices (410), such as a touchscreen, keyboard, mouse, microphone, touchpad, electronic pen, or any other type of input device. The communication interface (408) may include an integrated circuit for connecting the computing device (400) to a network (not shown) (e.g., a local area network (LAN), a wide area network (WAN) such as the Internet, mobile network, or any other type of network) and/or to another device, such as another computing device.

In one embodiment, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) (408, 410) may be locally or remotely connected to the computer processor(s) (402), non-persistent storage (404), and persistent storage (406). Many diverse types of computing devices exist, and the aforementioned input and output device(s) (410, 408) may take other forms.

1. A method for servicing queries, the method comprising:
receiving a query from a client;
parsing the query to generate a plurality of tokens;
making a first determination that an answer to the query can be generated from a cache entry in a cache associated with a token in the plurality of tokens.
wherein the cache entry comprises the token and a structured-data location, wherein the structured-data location is a pointer pointing to structured data stored in an archive, and wherein the archive is in a location separate from the cache entry, and
wherein the archive is utilized to supply the answer;
in response to the first determination, generating the answer to the query using a large language model (LLM); and
sending the answer to the client.

2. The method of claim 1, comprising:
receiving a second query from the client;
parsing the second query to generate a second plurality of tokens;
making a second determination that a second answer to the second query cannot be generated from any cache entry associated with any of the second plurality of tokens;
based on the second determination, sending a second token of the second plurality of tokens to an initial on-prem LLM to generate an LLM generated answer to the second query;
making a third determination that the LLM generated answer is greater than a scoring threshold;
based on the third determination, sending the LLM generated answer to the client; and
storing the second token and the LLM generated answer in the cache as a new cache entry.

3. The method of claim 1, comprising:
receiving a second query from the client;
parsing the second query to generate a second plurality of tokens;
making a second determination that a second answer to the second query cannot be generated from any cache entry associated with any of the second plurality of tokens;
based on the second determination, sending a second token of the second plurality of tokens to an initial on-prem LLM to generate an LLM generated answer to the second query;
making a third determination that the LLM generated answer to the client is not greater than a scoring threshold;
based on the third determination, making a fourth determination that a second on-prem LLM can generate a new token;
based on the fourth determination, sending the new token to the second on-prem LLM to generate a second on-prem LLM generated answer to the second query;
making a fifth determination that the second on-prem LLM generated answer is greater than the scoring threshold;
based on the fifth determination, sending the second on-prem LLM generated answer to the client; and
storing the new token and the second on-prem LLM generated answer in the cache as the new cache entry.

4. The method of claim 1, comprising:
receiving a second query from the client;
parsing the second query to generate a second plurality of tokens;
making a second determination that a second answer to the second query cannot be generated from any cache entry associated with any of the second plurality of tokens;
based on the second determination, sending a second token of the second plurality of tokens to an initial on-prem LLM to generate an LLM generated answer to the second query;
making a third determination that the LLM generated answer to the client is not greater than a scoring threshold;
making a fourth determination that the on-prem LLM cannot generate new tokens;
based on the fourth determination, sending the second token to a proprietary LLM to generate a proprietary LLM answer;
sending the proprietary LLM answer to the client in response to the second query;
storing the second token and the proprietary LLM generated answer in the cache as the new cache entry.

5. The method of claim 4, wherein the proprietary LLM comprises paid LLM services by a third party.

6. The method of claim 2, wherein the on-prem LLM comprises local LLM services that are opensource.

7. The method of claim 1, wherein parsing the query comprises sending the query to a large language model to receive the plurality of tokens.

8. A non-transitory computer readable medium comprising computer readable program code, which when executed by a computer processor enables the computer processor to perform a method for servicing queries, the method comprising:
receiving a query from a client;
parsing the query to generate a plurality of tokens;
making a first determination that an answer to the query can be generated from a cache entry in a cache associated with a token in the plurality of tokens; wherein the cache entry comprises the token and a structured-data location, wherein the structured-data location is a pointer pointing to structured data stored in an archive, and wherein the archive is in a location separate from the cache entry, and wherein the archive is utilized to supply the answer;
based on the first determination, generating the answer to the query using a large language model (LLM); and
sending the answer to the client.

9. The non-transitory computer readable medium of claim 8, comprising:
receiving a second query from the client;
parsing the second query to generate a second plurality of tokens;
making a second determination that a second answer to the second query cannot be generated from any cache entry associated with any of the second plurality of tokens;
based on the second determination, sending a second token of the second plurality of tokens to an initial on-prem LLM to generate an LLM generated answer to the second query;
making a third determination that the LLM generated answer is greater than a scoring threshold;
based on the third determination, sending the LLM generated answer to the client; and
storing the second token and the LLM generated answer in the cache as a new cache entry.

10. The non-transitory computer readable medium of claim 9, comprising:
receiving the second query from the client;
parsing the second query to generate the second plurality of tokens;
making the second determination that the second answer to the second query cannot be generated from any cache entry associated with any of the second plurality of tokens;
based on the second determination, sending the second token of the second plurality of tokens to an initial on-prem LLM to generate an LLM generated answer to the second query;
making the third determination that the LLM generated answer to the client is not greater than the scoring threshold;
based on the third determination, making a fourth determination that a second on-prem LLM can generate a new token;
based on the fourth determination, sending the new token to the second on-prem LLM to generate a second on-prem LLM generated answer to the second query;
making a fifth determination that the second on-prem LLM generated answer is greater than the scoring threshold;
based on the fifth determination, sending the second on-prem LLM generated answer to the client; and
storing the new token and the second on-prem LLM generated answer in the cache as the new cache entry.

11. The non-transitory computer readable medium of claim 9, comprising:
Receiving the second query from the client;
parsing the second query to generate the second plurality of tokens;
making the second determination that the second answer to the second query cannot be generated from any cache entry associated with any of the second plurality of tokens;
based on the second determination, sending the second token of the second plurality of tokens to an initial on-prem LLM to generate an LLM generated answer to the second query;
making the third determination that the LLM generated answer to the client is not greater than the scoring threshold;
making a fourth determination that the on-prem LLM cannot generate new tokens;
based on the fourth determination, sending the second token to a proprietary LLM to generate a proprietary LLM answer;
sending the proprietary LLM answer to the client in response to the second query;
storing the second token and the proprietary LLM generated answer in the cache as the new cache entry.

12. The non-transitory computer readable medium of claim 11, wherein the proprietary LLM comprises paid LLM services by a third party.

13. The non-transitory computer readable medium of claim 10, wherein the on-prem LLM comprises local LLM services that are opensource.

14. The non-transitory computer readable medium of claim 9, wherein parsing the query comprises sending the query to an LLM to receive the plurality of tokens.

15. A system for servicing queries, the system comprising:
an electronic device; and
a manager operatively connected to the electronic device and comprising a processor and memory, and configured to:
receive a query from a client;
parse the query to generate a plurality of tokens;
make a first determination that an answer to the query can be generated from a cache entry in a cache associated with a token in the plurality of tokens, wherein the cache entry comprises the token and a structured-data location, wherein the structured-data location is a pointer pointing to structured data stored in an archive, and wherein the archive is in a location separate from the cache entry, and wherein the archive is utilized to supply the answer;
based on the first determination, generate the answer to the query using a large language model (LLM); and
send the answer to the client.

16. The system of claim 15 comprising:
receiving a second query from the client;
parsing the second query to generate a second plurality of tokens;
making a second determination that a second answer to the second query cannot be generated from any cache entry associated with any of the second plurality of tokens;
based on the second determination, sending a second token of the second plurality of tokens to an initial on-prem LLM to generate an LLM generated answer to the second query;
making a third determination that the LLM generated answer is greater than a scoring threshold;
based on the third determination, sending the LLM generated answer to the client; and
storing the second token and the LLM generated answer in the cache as a new cache entry.

17. The system of claim 15, comprising:
receiving a second query from the client;
parsing the second query to generate a second plurality of tokens;
making a second determination that a second answer to the second query cannot be generated from any cache entry associated with any of the second plurality of tokens;
based on the second determination, sending a second token of the second plurality of tokens to an initial on-prem LLM to generate an LLM generated answer to the second query;
making a third determination that the LLM generated answer to the client is not greater than a scoring threshold;
based on the third determination, making a fourth determination that a second on-prem LLM can generate a new token;
based on the fourth determination, sending the new token to the second on-prem LLM to generate a second on-prem LLM generated answer to the second query;
making a fifth determination that the second on-prem LLM generated answer is greater than the scoring threshold;
based on the fifth determination, sending the second on-prem LLM generated answer to the client; and
storing the new token and the second on-prem LLM generated answer in the cache as the new cache entry.

18. The system of claim 15, comprising:
receiving a second query from the client;
parsing the second query to generate a second plurality of tokens;
making a second determination that a second answer to the second query cannot be generated from any cache entry associated with any of the second plurality of tokens;
based on the second determination, sending a second token of the second plurality of tokens to an initial on-prem LLM to generate an LLM generated answer to the second query;
making a third determination that the LLM generated answer to the client is not greater than a scoring threshold;
making a fourth determination that the on-prem LLM cannot generate new tokens;
based on the fourth determination, sending the second token to a proprietary LLM to generate a proprietary LLM answer;
sending the proprietary LLM answer to the client in response to the second query;
storing the second token and the proprietary LLM generated answer in the cache as the new cache entry.

19. The system of claim 18, wherein the proprietary LLM comprises paid LLM services by a third party.

20. The system of claim 15, wherein parsing the query comprises sending the query to a large language model to receive the plurality of tokens.
